(19) United States
(12) Patent Application Publication
(10) Pub. No.: US 2009/0202889 A1
(43) Pub. Date: Aug. 13, 2009

(54) Protection Circuit And Battery Pack

(75) Inventor: Iichiro Mori, Hyogo (JP)

Correspondence Address: MCDERMOTT WILL & EMERY LLP, 600 13TH STREET, NW, WASHINGTON, DC, 20005-3096, US

(73) Assignee: PANASONIC CORPORATION, Osaka (JP)

(21) Appl. No.: 11/794,663

(22) PCT Filed: May 10, 2006
(86) PCT No.: PCT/JP2006/309386

§ 371 Date: Jul. 3, 2007

(30) Foreign Application Priority Data
May 10, 2005 (JP) 2005-137365
May 11, 2005 (JP) 2005-138900

(51) Int. Cl. H01M 10/48; H02J 7/00; H01M 10/44; H02J 7/04

(52) U.S. Cl. 429/62; 320/134; 320/154

(57) ABSTRACT

A secondary battery is protected from overcharging and excessive discharge current by a simple circuit. A comparator (CMP1) detects overcharging by comparing a charging voltage. (Vc) of a secondary battery (6) with a reference voltage (Vref1). A transistor (Q1) is turned on to turn the heater (R2) on if overcharging is detected by the comparator (CMP1). A PTC element (SW1) is turned off to cut off a charge current when being heated by the heater to reach a specified operating temperature (Tsw1). On the other hand, when a discharge current from the secondary battery (6) becomes excessive, the PTC element (SW1) self-heats by the discharge current and is turned off to cut off a discharge current upon reaching the operating temperature (Tsw1).

### FIELD OF TECHNOLOGY

The present invention relates to a protection circuit for protecting a secondary battery from overcharging and excessive discharge current, and a battery pack.

### BACKGROUND ART

FIG. 12 is a circuit diagram showing the construction of a battery pack according to background art. A battery pack 101 shown in FIG. 12 is provided with a protection circuit 102 and a secondary battery 103. The secondary battery 103 is, for example, a rechargeable secondary battery such as a lithium ion secondary battery, a lithium polymer secondary battery, a nickel-metal-hydride secondary battery or a nickel-cadmium secondary battery. In the case of overcharging or excessive discharge current, such a secondary battery might have characteristics thereof such as cycle life degraded or might undergo expansion, deformation and the like. Accordingly, the battery pack 101 is provided with the protection circuit 102 for protecting the secondary battery 103 from overcharging or excessive discharge current (see, for example, patent document 1).

The protection circuit 102 includes external connection terminals 104, 105, FETs (Field Effect Transistors) 106, 107, reference voltage generators 108, 109, comparators 110, 111, a resistor 112 and a logical circuit 113.

The external connection terminals 104, 105 are connection terminals for connecting a charging device for charging the secondary battery 103 and for connecting a power source for driving a mobile device such as a mobile phone or a digital camera, an electric tool, a robot or an electric automobile that is driven by a discharge current from the secondary battery 103. The external connection terminal 104, the secondary battery 103, the FET 106, the FET 107 and the external connection terminal 105 are connected in series.

The FET 106 is oriented such that an anode of a parasite diode is connected to the secondary battery 103, whereas the FET 107 is oriented such that an anode of a parasitic diode is connected to the external connection terminal 105. The FET 106 is used as a switch for protection from excessive discharge for cutting off a discharge current if the discharge current of the secondary battery 103 becomes excessive, whereas the FET 107 is used as a switch for protection from overcharging for cutting off a charge current if the secondary battery 103 is overcharged.

Further, a positive electrode terminal of the secondary battery 103 is connected to a plus terminal of the comparator 110, a reference voltage Vref1 outputted from the reference voltage generator 108 is applied to a minus terminal of the comparator 110, and an output terminal of the comparator 110 is connected to the logical circuit 113. A voltage for detecting the overcharging of the secondary battery 103 is set as the reference voltage Vref1. The comparator 110 outputs a detection signal representing overcharging to the logical circuit 113 if the secondary battery 103 is charged by an unillustrated charging device connected to the external connection terminals 104, 105 and a terminal voltage of the secondary battery 103 exceeds the reference voltage Vref1.

Further, a connection point of the FETS 106, 107 is connected to a minus terminal of the comparator 111 via the resistor 112, and a reference voltage Vref2 outputted from the reference voltage generator 109 is applied to the plus terminal of the comparator 111. Thus, a voltage drop caused by the on-resistance of the FET 106 resulting from the flow of a discharge current from the secondary battery 103 through the FET 106 is applied to the minus terminal of the comparator 111 via the resistor 112. The reference voltage Vref2 is set to a voltage corresponding to a voltage drop caused by the on-resistance of the FET 106, for example, in the case where a maximum discharge current within such a range as not to cause the characteristic degradation of the secondary battery 103 flows through the FET 106.

The comparator 111 detects an increase of the voltage drop in the FET 106 and outputs a detection signal representing overcurrent discharge to the logical circuit 113, for example, if the external connection terminals 104, 105 are short-circuited together due to the contact with a metal piece or the breakdown of a load device connected to the external connection terminals 104, 105 and an excessive discharge current flows from the secondary battery 103.

The logical circuit 113 turns the FET 107 off to stop the charging of the secondary battery 103 if a detection signal representing overcharging is outputted from the comparator 110 while turning the FET 106 off to stop the discharge of the secondary battery 103 if a detection signal representing overcurrent discharge is outputted from the comparator 111. In this way, the protection circuit 102 protects the secondary battery 103 from overcharging and overcurrent discharge.

Further, a known protection circuit for protecting a secondary battery from overcharging and overcurrent discharge in this way is such as in a battery pack 121 shown in FIG. 13 in which a secondary battery 122 and a PTC element 123 are connected in series. If the PTC element 123 is heated due to the heat generation of the secondary battery 122 or the self-heat generation resulting from overcharging, for example, in the case of the breakdown of a charging device 126 connected with external connection terminals 124, 125, the PTC element 123 is turned off to cut off a charge current to protect the secondary battery 122.

Another known protection circuit is such as in a battery pack 131 shown in FIG. 14 in which a PTC (Positive Temperature Coefficient) element 132 in the form of a thermistor that is turned off in the case of exceeding a specified temperature is used, and a secondary battery 133 and the PTC element 132 are connected in series. If the PTC element 132 is heated due to the heat generation of the secondary battery 132 or the self-heat generation resulting from overcharging, for example, in the case of the breakdown of a charging device 136 connected with external connection terminals 134, 135, the PTC element 132 is turned off to cut off a charge current to protect the secondary battery 133.

However, the protection circuit 102 shown in FIG. 12 cannot cut off the discharge current and the charge current having different directions of current flows by one FET since the FET includes a parasitic diode, and it has been necessary to provide the FET 106 for cutting off the discharge current and the FET 107 for cutting off the charge current. Further, the reference voltage generator 108 and the comparator 110 are necessary to detect overcharging; the reference voltage generator 109, the comparator 111, and the resistor 112 are necessary to detect the excessive discharge current; and the logical circuit 113 is necessary to turn the two FETS 106, 107 on and off in accordance with the output signals of the comparators 110, 111. This has caused inconvenience of increasing the circuit size of the protection circuit 102.

Further, in a construction for protecting the secondary battery from overcharging by connecting a temperature switch, which operates with temperature, such as a PTC element with the secondary battery in series as shown in FIGS. 13 and 14, accuracy in detecting overcharging is low. Thus, if the secondary battery continues to be charged with such a charge current as not to suddenly increase temperature as in the case where a battery pack is charged, for example, using an inferior charging device having poor accuracy in controlling the charging voltage, the secondary battery is overcharged without the temperature switch operating, thereby causing inconvenience of degrading the characteristics of the secondary battery and leading to a likelihood of expanding or deforming the battery.

Patent Document 1: Japanese Unexamined Patent Publication No. H04-75430

### DISCLOSURE OF THE INVENTION

In view of the above problems, an object of the present invention is to provide a protection circuit and a battery pack capable of protecting a secondary battery from overcharging and excessive discharge current by a simple circuit.

The present invention is directed to a protection circuit, comprising a first and a second connection terminals for connecting a charging device for charging a secondary battery and/or a load device driven by a discharge current from the secondary battery; a third and a fourth connection terminals connected with the opposite electrodes of the secondary battery; a PTC element that is provided between the first and third connection terminals and turned off in the case of exceeding a specified temperature; a heater for heating the PTC element; and an overcharging protection controller for turning the PTC element off by causing the heater to generate heat if a voltage of the secondary battery exceeds a preset reference voltage.

With this construction, if the discharge current from the secondary battery exceeds a specified current value, the PTC element is turned off by the self-heat generation to cut off the discharge current. Thus, the secondary battery can be protected from excessive discharge current. This obviates the need for the FET 106 for preventing overcharging, the reference voltage generator 109 and the comparator 111 for detecting an excessive discharge current, shown in FIG. 12, enabling the circuit to be simplified. Further, if the charging voltage exceeds the preset reference voltage, the heater is caused to generate heat by the overcharging protection controller and the PTC element is turned off to cut off a charge current by being heated by the heater. Thus, the secondary battery can be protected from overcharging. Further, since the discharge current and the charge current can be cut off by one PTC element, the circuit can be simplified.

The present invention is also directed to a protection circuit, comprising a first and a second connection terminals for connecting a charging device for charging a secondary battery and/or a load device driven by a discharge current from the secondary battery; a third and a fourth connection terminals connected with the opposite electrodes of the secondary battery; a PTC element that is provided between the first and third connection terminals and turned off in the case of exceeding a specified temperature; an overcharging preventing transistor connected between the PTC element and the first connection terminal; and an overcharging detector for detecting whether or not a voltage of the secondary battery has exceeded a specified reference voltage and turning the overcharging preventing transistor off if the voltage of the secondary battery has exceeded the reference voltage.

With this construction, if the discharge current from the secondary battery exceeds a specified current value, the PTC element is turned off by the self-heat generation to cut off the discharge current. Thus, the secondary battery can be protected from excessive discharge current. This obviates the need for the FET 106 for preventing overcharging, the reference voltage generator 109 and the comparator 111 for detecting an excessive discharge current, shown in FIG. 12, enabling the circuit to be simplified. Further, if the charging voltage exceeds the preset reference voltage, the overcharging preventing transistor is turned off by the overcharging protection controller to cut off a charge current to the secondary battery. Therefore, the secondary battery can be protected from overcharging.

The present invention is further directed to a protection circuit according to the present invention comprises a first and a second connection terminals for connecting a charging device for charging a secondary battery and/or a load device driven by a discharge current from the secondary battery; a third and a fourth connection terminals connected with the opposite electrodes of the secondary battery; a first and a second PTC elements that are connected in series between the first and third connection terminals and turned off in the case of exceeding a specified temperature; a heater having one end thereof connected between the first and second PTC elements for heating the first and second PTC elements; a switching element having one end thereof connected with the other end of the heater and the other end thereof connected to the second and fourth connection terminals; and an overcharging detector for turning the switching element on if a voltage of the secondary battery has exceeded a specified reference voltage while turning the switching element off if the voltage of the secondary battery falls to or below the reference voltage.

With this construction, if the discharge current from the secondary battery exceeds a specified current value, the first and second PTC elements are turned off by the self-heat generation to cut off the discharge current. Thus, the secondary battery can be protected from excessive discharge current. This obviates the need for the FET 106 for preventing overcharging, the reference voltage generator 109 and the comparator 111 for detecting an excessive discharge current, shown in FIG. 12, enabling the circuit to be simplified. Further, if the voltage of the secondary battery exceeds the preset reference voltage, the switching element is turned on by the overcharging detector, a charge current flows to the heater, and the first and second PTC elements are heated by the heater to be turned off, whereby the charge current to the secondary battery is cut off to enter an overcharging protecting state. Therefore, the secondary battery can be protected from overcharging.

Further, since the discharge current and the charge current can be cut off by the first and second PTC elements, the circuit can be simplified. Furthermore, since the heater is connected between the first and second PTC elements, a weak overcharging current supplied from the charging device to the secondary battery during the overcharging protecting operation flows to the heater and is discharged by the heater. This can prevent the progress of the overcharging of the secondary battery by the weak current during the overcharging protecting operation.

Further, since two PTC elements are provided, even if one PTC element is broken, the secondary battery can be protected from overcharging and excessive discharge current by the other PTC element, wherefore safety and reliability can be improved.

The present invention is still further directed to a battery pack comprising a secondary battery and the above protection circuit.

With this construction, a battery pack capable of protecting the secondary battery from overcharging and excessive discharge current can be provided while the circuit is simplified.

### BRIEF DESCRIPTION OF THE DRAWINGS

FIG. 1 is an exploded perspective view showing one example of a battery pack according to a first embodiment of the invention,

FIG. 2 is a circuit diagram showing one example of the electrical construction of the battery pack shown in FIG. 1,

FIG. 3 is a graphical representation showing a temperature characteristic of a PTC element, wherein vertical axis represents the resistance of the element and horizontal axis represents the temperature of the element,

FIG. 4 is a circuit diagram showing one example of the electrical construction of a battery pack according to a second embodiment of the invention,

FIG. 5 is a circuit diagram showing one example of the electrical construction of a battery pack according to a third embodiment of the invention,

FIG. 6 is a circuit diagram showing one example of the electrical construction of a battery pack according to a fourth embodiment of the invention,

FIG. 7 are construction diagrams of a protection circuit, wherein FIG. 7A shows wiring patterns of the protection circuit and FIG. 7B is a section of along 7b-7b,

FIG. 8 are construction diagrams of the protection circuit, wherein FIG. 8A is a top view of the protection circuit and FIG. 8B shows wiring patterns formed on the underside of a circuit board of the protection circuit,

FIG. 9 is a circuit diagram showing one example of the electrical construction of a battery pack according to a fifth embodiment of the invention,

FIG. 10 are construction diagrams of two PTC elements SW1, SW2, wherein FIG. 10A is a perspective view, FIG. 10B is a diagram showing a mounted state of the PTC elements SW1, SW1 on the protection circuit and FIG. 10C is a section diagrammatically showing the PTC elements SW1, SW2,

FIG. 11 is a construction diagram of a conventional PTC element,

FIG. 12 is a circuit diagram showing the construction of a battery pack according to background art,

FIG. 13 is a circuit diagram showing the construction of a battery pack according to background art, and

FIG. 14 is a circuit diagram showing the construction of a battery pack according to background art.

### BEST MODES FOR EMBODYING THE INVENTION

Hereinafter, embodiments of the present invention are described with reference to the accompanying drawings. it should be noted that elements identified by the same reference numerals are the same in the respective figures and are not repeatedly described.

### First Embodiment

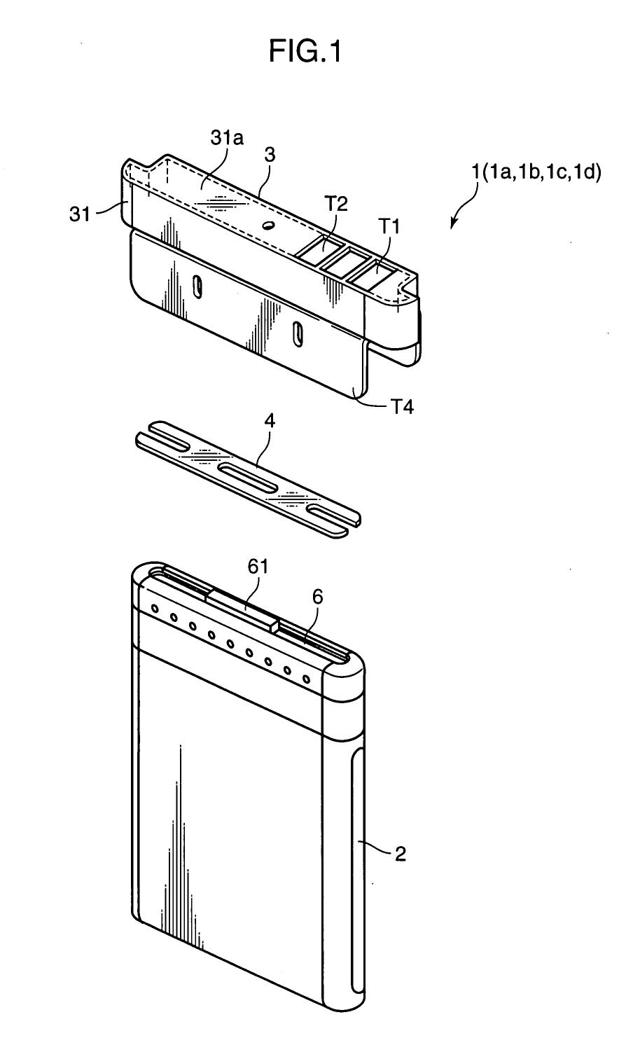

FIG. 1 is an exploded perspective view showing one example of a battery pack according to one embodiment of the present invention. A battery pack 1 shown in FIG. 1 is provided with a container 2 in the form of a bottomed tube, an external connection terminal unit 3, and a plate-shaped spacer 4 to be inserted between the container 2 and the external connection terminal unit 3. A secondary battery 6 is accommodated into the container 2 and sealed by caulking, and a positive electrode terminal 61 projecting from the secondary battery 6 projects through an opening end of the container 2. The container 2 is made of a steel sheet having the outer surface nickel plated, and a negative electrode of the secondary battery 6 is connected with the container 2 inside the container 2.

The external connection terminal unit 3 includes a casing 31 formed, for example, by resin molding, and connection terminals T1, T2 used to connect a charging device and load devices are exposed on the outer surface of the casing 31. A connection terminal T4 connected with the connection terminal T2 and made, for example, of a sheet metal projects in a connecting direction with the container 2.

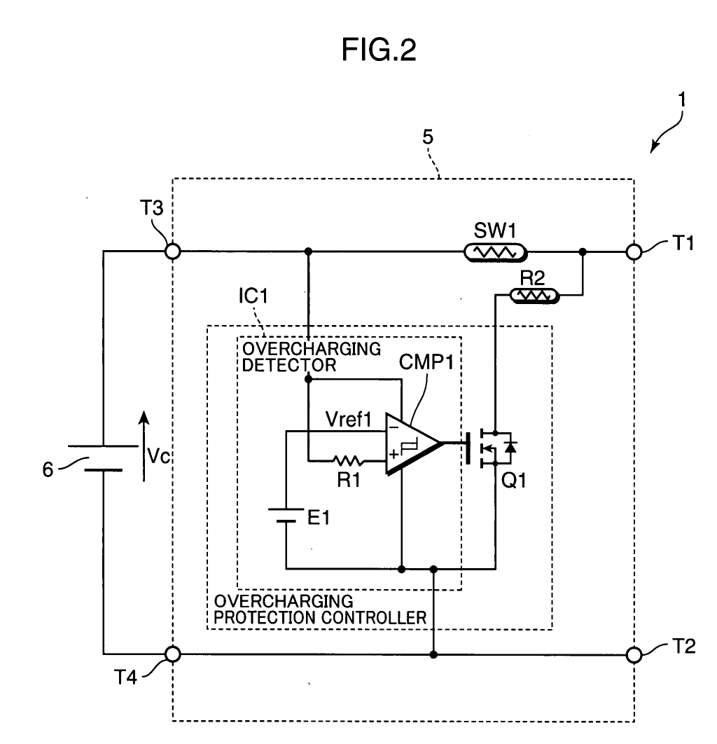

FIG. 2 is a circuit diagram showing one example of the electrical construction of the battery pack 1 shown in FIG. 1. The battery pack 1 shown in FIG. 1 is provided with a protection circuit 5 and the secondary battery 6. The secondary battery 6 is, for example, a rechargeable secondary battery such as a lithium ion secondary battery, a lithium polymer secondary battery, a nickel-metal-hydride secondary battery or a nickel-cadmium secondary battery. The protection circuit 5 is for protecting the secondary battery 6 from overcharging and excessive discharge current.

The protection circuit 5 is arranged in the external connection terminal unit 3 and includes the connection terminal T1 (first connection terminal), the connection terminal T2 (second connection terminal), a connection terminal T3 (third connection terminal), the connection terminal T4 (fourth connection terminal), a PTC element SW1, a comparator CMP1, a reference voltage generator E1, a resistor R1, a transistor Q1 and a heater R2. The connection terminals T3 and T4 are connection terminals to be connected to the opposite electrodes of the secondary battery 6.

The connection terminals T1 and T2 are connection terminals for the connection of an unillustrated charging device for charging the secondary battery 6 and/or load devices driven by a discharge current from the secondary battery 6. The load devices are various battery-driven electric devices such as a mobile phone, a digital camera, a video camera, a portable personal computer and an electric tool.

The PTC element SW1 is a polymer PTC thermistor (PTC: Positive Temperature Coefficient=thermistor having a positive temperature coefficient) and a return-type heat-sensitive switch whose resistance value suddenly changes when the temperature thereof increases above a certain temperature.

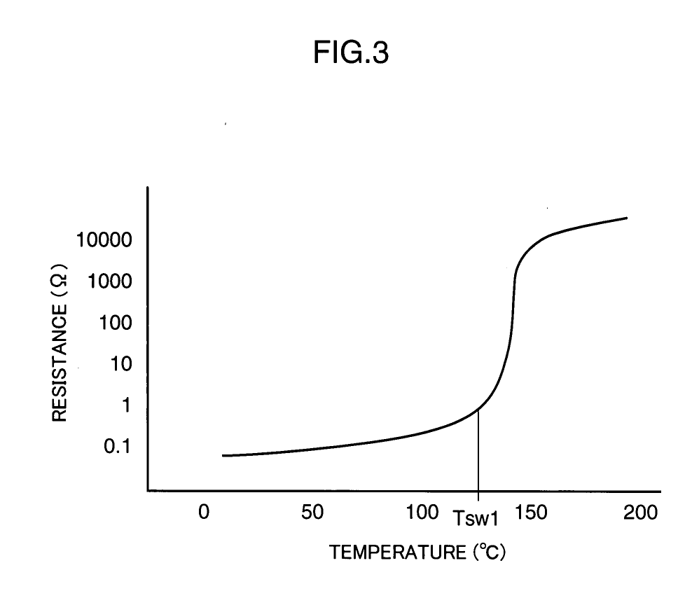

FIG. 3 is a graphical representation showing a temperature characteristic of a PTC element, wherein vertical axis represents resistance value and horizontal axis represents temperature. As shown in FIG. 3, it can be understood that the resistance of the PTC element moderately increases in a temperature area below 125° C., but suddenly increases approximately after exceeding 125° C.

Here, a temperature at an inflection point where the inclination of a graph becomes steep is called an operating temperature Tsw1. Accordingly, the PTC element SW1 is turned off if a temperature inside it exceeds the operating temperature Tsw1 due to an overcurrent or external heating. A maximum temperature within such a temperature range as not to degrade characteristics of the secondary battery 6 is, for example, set as the operating temperature Tsw1.

A PTC thermistor having a positive temperature characteristic, i.e. whose resistance value increases and decreases with temperature is used as the heater R2. Thus, if a voltage is applied to the heater R2, the resistance value of the heater R2 increases due to the self-heat generation of the heater R2, thereby decreasing a current flowing through the heater R2, with the result that the temperature of the heater R2 finally stabilizes at a finally attained temperature Th. The finally attained temperature Th is set at such a temperature that is above the operating temperature Tsw1 of the PTC element SW1 and damages neither the secondary battery 6 nor the protection circuit 5. This can suppress the damage of the secondary battery 6 and the protection circuit 5 due to the heat generation of the heater R2.

The connection terminal T3 is connected to the positive terminal of the secondary battery 6, and the negative electrode of the secondary battery 6 is connected to the connection terminal T4. Further, the connection terminal T1 is connected to a power supply terminal of the comparator CMP1 via the PTC element SW1, and the connection terminal T2 is connected to a ground terminal of the comparator CMP1 so that a supply voltage for the operation of the comparator CMP1 is supplied from the secondary battery 6.

The transistor Q1 is an n-channel field effect transistor and has a gate thereof connected to an output terminal of the comparator CMP1, a drain thereof connected to the heater R2 and a source thereof connected to the connection terminal T2.

The reference voltage generator E1 is a voltage generating circuit for outputting a reference voltage Vref1 that serves as a judgment standard for detecting the overcharging of the secondary battery 6. Thus, when the reference voltage Vref1 is applied to the non-inverting input terminal (minus terminal) of the comparator CMP1 and a terminal voltage between the connection terminals T3 and T4, i.e. a voltage Vc of the secondary battery 6 exceeds the reference voltage Vref1, the comparator CMP1 sets a gate voltage of the transistor Q1 to high level, thereby turning the transistor Q1 on to cause the heater R2 to generate heat.

A comparator whose input voltage has a hysteresis characteristic is used as the comparator CMP1 in order to reduce the influence of noise when the charging voltage Vc is in the neighborhood of the reference voltage Vref1. The PTC element SW1 is connected to a non-inverting input terminal (plus terminal) of the comparator CMP1 via the resistor R1.

The comparator CMP1, the resistor R1 and the reference voltage generator E1 are, for example, integrated into an integrated circuit IC1. In this case, the integrated circuit IC1 and the transistor Q1 correspond to one example of an overcharging protection controller. Further, the comparator CMP1, the resistor R1 and the reference voltage generator E1 correspond to one example of an overcharging detector.

Next, the operation of the protection circuit 5 constructed as above is described. First, a protecting operation of the protection circuit 5 from overcharging is described. First, when an unillustrated charging device is connected with the connection terminals T1, T2 to apply a charging voltage between the connection terminals T1 and T2 with the PTC element SW1 turned on, the secondary battery 6 is charged with the charging voltage via the PTC element SW1 and the connection terminal T3.

The charging voltage Vc is normally up to, for example, 4.2 V. For example, 4.3 V is set as the reference voltage Vref1 in the reference voltage generator E1.

Accordingly, if the charging voltage Vc exceeds Vref1, for example, because the charging device breaks down or the output voltage accuracy thereof is low, the transistor Q1 is turned on by the comparator CMP1 to cause a current to flow into the heater R2 from the connection terminal T1, thereby heating the PTC element SW1. When the temperature of the PTC element SW1 reaches the operating temperature Tsw1, the PTC element SW1 is turned off to cut off the charge current, thereby protecting the secondary battery 6 from overcharging.

Subsequently, if the voltage at the connection terminal T3 falls to or below the reference voltage Vref1 by the PTC element SW1 being turned off to cut off the charge current, the transistor Q1 is turned off by the comparator CMP1 to zero the current flowing into the heater R2. When the temperature of the PTC element SW1 falls below the operating temperature Tsw1 by natural cooling, the PTC element SW1 is turned on to return from an overcharging protecting state to a normal state.

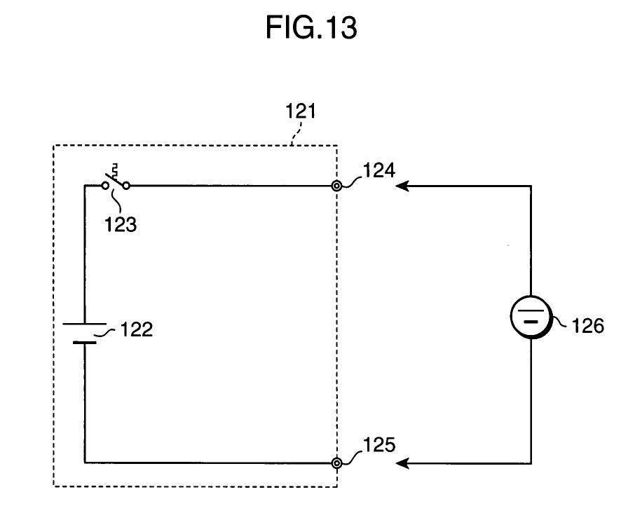

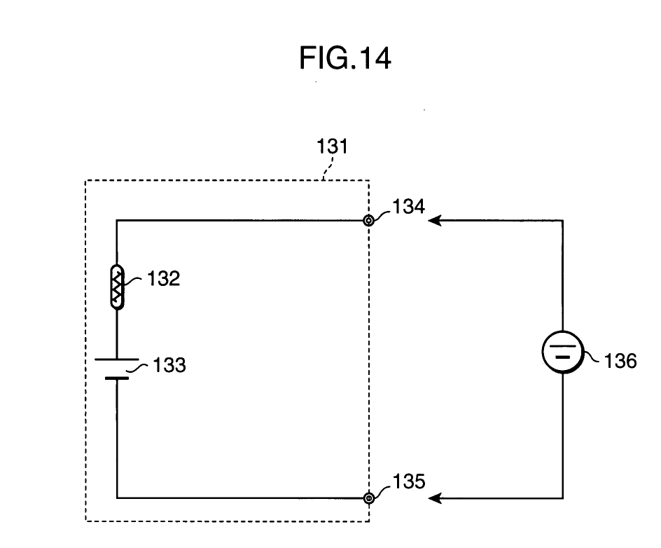

Since overcharging is detected by the comparator CMP1 and the PTC element SW1 is heated by the heater R2 to be turned off in this case, accuracy in detecting overcharging can be improved as compared, for example, to the case where protection from overcharging is carried out only by the temperature switch connected in series with the secondary battery as shown in FIGS. 13 and 14. Therefore, likelihood of overcharging the secondary battery 6 without performing the overcharging protection, degrading the characteristics of the secondary battery 6 or causing the expansion or deformation of the secondary battery 6 can be reduced.

Next, a protecting operation of the protection circuit 5 in the case where a discharge current from the secondary battery 6 becomes excessive is described. First, if the connection terminals T1, T2 are short-circuited or a resistance value between the connection terminals T1 and T2 becomes low with the PTC element SW1 turned on, for example, because a metal piece touches the connection terminals T1, T2 or an unillustrated mobile phone or a like load device connected with the connection terminals T1, T2 breaks down, a current discharged from the secondary battery 6 via the PTC element SW1 increases and the PTC element SW1 is heated.

When the temperature of the PTC element SW1 reaches the operating temperature Tsw1, the PTC element SW1 is turned off to cut off the discharge current of the secondary battery 6, thereby protecting the secondary battery 6 from excessive discharge current.

Next, the case where the integrated circuit IC1 has broken down during the charging is described. If the integrating circuit IC1 breaks down during the charging and can no longer execute a voltage control for the charging device, the secondary battery 6 goes beyond a fully charged state to enter an overcharged state.

However, if the secondary battery 6 is overcharged, the temperature of the secondary battery 6 itself increases to heat the PTC element SW1. Because the secondary battery 6 and the PTC element SW1 are thermally coupled, the PTC element SW1 is turned off to cut off the charge current from the charging device when the temperature thereof reaches the operating temperature Tsw1. In this way, the protection circuit 5 performs the overcharging protecting operation.

As described above, according to the battery pack 1 of the first embodiment, the PTC element is turned off by the self-heat generation to cut off the discharge current if the discharge current from the secondary battery exceeds the specified current value. Thus, the secondary battery 6 can be protected from excessive discharge current. Further, if the charging voltage exceeds the preset reference voltage Vref1, the heater is caused to generate heat by the overcharging protection controller and the PTC element SW1 is turned off to cut off the charge current by being heated by the heater. Thus, the secondary battery 6 can be protected from overcharging. Further, since the discharge current and the charge current can be cut off by one PTC element SW1, the circuit can be simplified. Furthermore, since the charging voltage from the charging device is cut off if the PTC element SW1 is heated by the secondary battery 6 to reach the operating temperature Tsw1, the secondary battery 6 can be protected from overcharging even if the integrated circuit IC1 breaks down during the charging.

### Second Embodiment

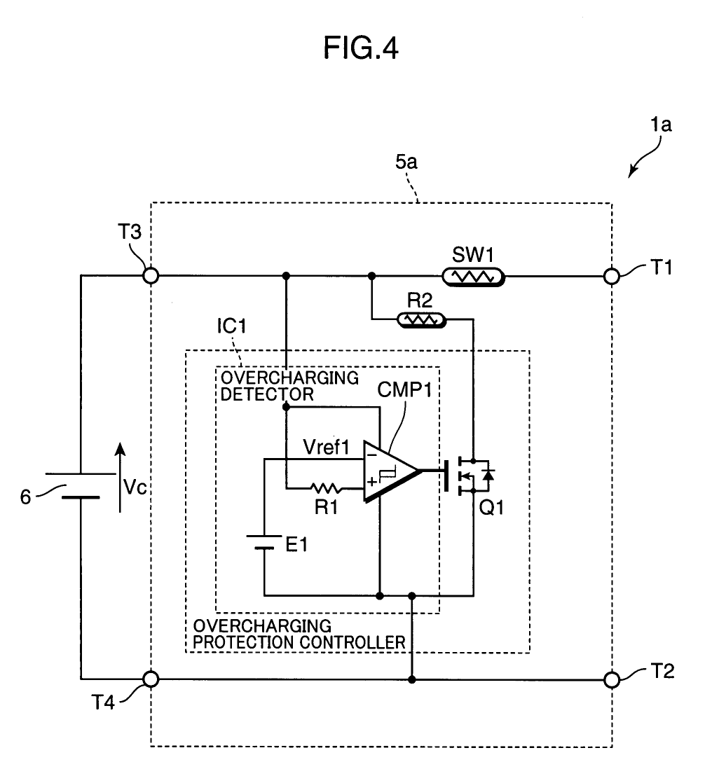

Next, a battery pack according to a second embodiment of the present invention is described. The external appearance of a battery pack 1a according to the second embodiment of the present invention is similar to that of the battery pack 1 shown in FIG. 1. FIG. 4 is a circuit diagram showing one example of the electrical construction of the battery pack 1a according to the second embodiment of the invention. The battery pack 1a shown in FIG. 4 differs from the battery pack 1 shown in FIG. 2 in the construction of the protection circuit 5. Specifically, the heater R2 is connected to a terminal of the PTC element SW1 connected to the connection terminal T1 in the protection circuit 5 according to the first embodiment, whereas a heater R2 is connected to a terminal of a PTC element SW1 connected to a secondary battery 6 in a protection circuit 5a according to the second embodiment.

Next, the operation of the protection circuit 5a according to the second embodiment is described. First, a protecting operation of the protection circuit 5a from overcharging is described. First, when an unillustrated charging device is connected with connection terminals T1, T2 to apply a charging voltage between the connection terminals T1 and T2 with the PTC element SW1 turned on, the secondary battery 6 is charged with the charging voltage via the PTC element SW1 and a connection terminal T3.

If the charging voltage Vc exceeds Vref1, for example, because the unillustrated charging device breaks down or the output voltage accuracy thereof is low, a transistor Q1 is turned on by a comparator CMP1 to cause a current to flow into the heater R2 from the connection terminal T1 via the PTC element SW1, thereby heating the PTC element SW1. When the temperature of the PTC element SW1 reaches an operating temperature Tsw1, the PTC element SW1 is turned off to cut off a charge current, entering an overcharging protecting state where the secondary battery 6 is protected from overcharging.

In an off-state of the PTC element SW1, a slight current flows through the PTC element SW1. However, since the heater R2 is connected to the terminal of the PTC element SW1 connected to the secondary battery 6 in the second embodiment, a weak current flowing through the PTC element SW1 in the overcharging protecting state flows to the transistor Q1 that is on. As a result, the overcharging of the secondary battery 6 can be more securely prevented.

Subsequently, if a voltage at the connection terminal T3 falls to or below the reference voltage Vref1 by the PTC element SW1 being turned off to cut off the charge current, the transistor Q1 is turned off by the comparator CMP1 to zero the current flowing into the heater R2. When the temperature of the PTC element SW1 falls below the operating temperature Tsw1 by natural cooling, the PTC element SW1 is turned on to return from the overcharging protecting state to a normal state.

Next, a protecting operation of the protection circuit 5a in the case where a discharge current from the secondary battery 6 becomes excessive is described. First, if the connection terminals T1, T2 are short-circuited or a resistance value between the connection terminals T1 and T2 becomes low with the PTC element SW1 turned on, for example, because a metal piece touches the connection terminals T1, T2 or an unillustrated mobile phone or a like load device connected with the connection terminals T1, T2 breaks down, the discharge current from the secondary battery 6 increases to heat the PTC element SW1.

When the temperature of the PTC element SW1 reaches the operating temperature Tsw1, the PTC element SW1 is turned off to cut off the discharge current of the secondary battery 6, thereby protecting the secondary battery 6 from excessive discharge current.

As described above, according to the battery pack 1a of the second embodiment, the overcharging of the secondary battery 6 can be more securely prevented in addition to the effects of the first embodiment since the heater R2 is connected to the terminal of the PTC element SW1 connected to the secondary battery 6.

### Third Embodiment

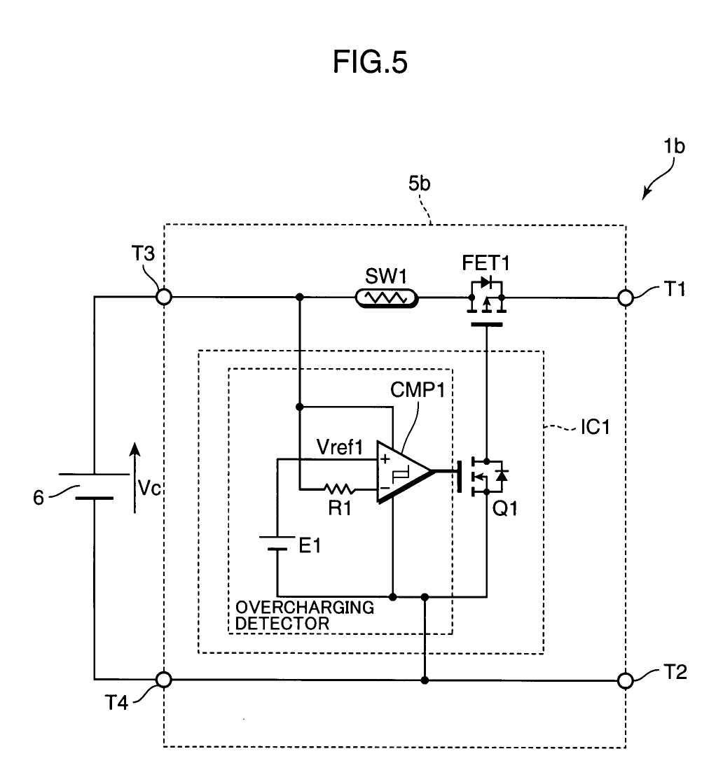

Next, a battery pack according to a third embodiment of the present invention is described. The external appearance of a battery pack 1b according to the third embodiment of the present invention is similar to that of the battery pack 1 shown in FIG. 1. FIG. 5 is a circuit diagram showing one example of the electrical construction of the battery pack 1b according to the third embodiment of the invention. The battery pack 1b shown in FIG. 5 differs from the battery pack 1 shown in FIG. 2 in the construction of a protection circuit 5b. Specifically, the protection circuit 5b shown in FIG. 5 is characterized by omitting the heater R2, connecting an overcharging preventing transistor FET1 to the PTC element SW1, and incorporating a transistor (switching transistor) Q1 into an integrated circuit IC1 in the protection circuit 5.

The overcharging preventing transistor FET1 is a p-channel field effect transistor and has a gate thereof connected to a drain of the transistor Q1, a drain thereof connected to the PTC element SW1 and a source thereof connected to a connection terminal T1. A reference voltage generator E1 is connected to a plus terminal of a comparator CMP1, and the PTC element SW1 is connected to a minus terminal thereof via a resistor R1.

Next, the operation of the protection circuit 5b according to the third embodiment is described. Since a charging voltage Vc is equal to or below a reference voltage Vref1 in a normal state, the comparator CMP1 sets a gate voltage of the transistor Q1 to high level, thereby turning the transistor Q1 on. At this time, the secondary battery 6 is charged with the charging voltage Vc applied thereto since the overcharging preventing transistor FET1 is turned on.

If the charging voltage Vc exceeds Vref1, for example, because the unillustrated charging device breaks down or the output voltage accuracy thereof is low, the comparator CMP1 sets the gate voltage of the transistor Q1 to low level, thereby turning the transistor Q1 off. In this way, the overcharging preventing transistor FET1 is turned off to cut off a charge current, whereby the secondary battery 6 is protected from overcharging.

If the charging voltage Vc of the secondary battery 6 falls to or below the reference voltage Vref1 again, the transistor Q1 and the overcharging preventing transistor FET1 are turned on by the comparator CMP1, thereby returning to a normal state from an overcharging protecting state.

Next, a protecting operation of the protection circuit 5b in the case where a discharge current from the secondary battery 6 becomes excessive is described. First, when the connection terminals T1, T2 are short-circuited or a resistance value between the connection terminals T1 and T2 becomes low with the PTC element SW1 turned on, for example, because a metal piece touches the connection terminals T1, T2 or an unillustrated mobile phone or like load device connected with the connection terminals T1, T2 breaks down, a discharge current from the secondary battery 6 increases and the PTC element SW1 self-heats.

When the temperature of the PTC element SW1 reaches the operating temperature Tsw1, the PTC element SW1 is turned off to cut off the discharge current of the secondary battery 6, thereby protecting the secondary battery 6 from excessive discharge current.

Next, the case where the integrated circuit IC1 and the overcharging preventing transistor FET1 have broken down during the charging is described. If the integrating circuit IC1 breaks down during the charging and can no longer execute a voltage control for the charging device, the secondary battery 6 goes beyond a fully charged state to enter an overcharged state.

However, if the secondary battery 6 is overcharged, the temperature of the secondary battery 6 itself increases to heat the PTC element SW1. The PTC element SW1 is turned off to cut off the charge current from the charging device when the temperature thereof reaches the operating temperature Tsw1. In this way, the protection circuit 5b performs the overcharging protecting operation.

As described above, according to the battery pack 1b of the third embodiment, the transistor Q1 and the overcharging preventing transistor FET1 are turned off if the charging voltage Vc exceeds the reference voltage Vref1, wherefore the secondary battery 6 can be protected from overcharging. Further, if the discharge current becomes excessive and the temperature of the PTC element SW1 reaches the operating temperature Tsw1, the discharge current is cut off, wherefore the flow of excessive discharge current toward the secondary battery 6 can be prevented. Further, the PTC element SW1 is heated by the secondary battery 6 and cuts off the charge current from the charging device upon reaching the operating temperature Tsw1. Thus, even if the integrating circuit IC1 breaks down during the charging, the secondary battery 6 can be protected from overcharging.

Although the transistor Q1 is provided in the third embodiment, the present invention is not limited thereto and the transistor Q1 may be omitted and the comparator CMP1 may directly turn the overcharging preventing transistor FET1 on and off.

### Fourth Embodiment

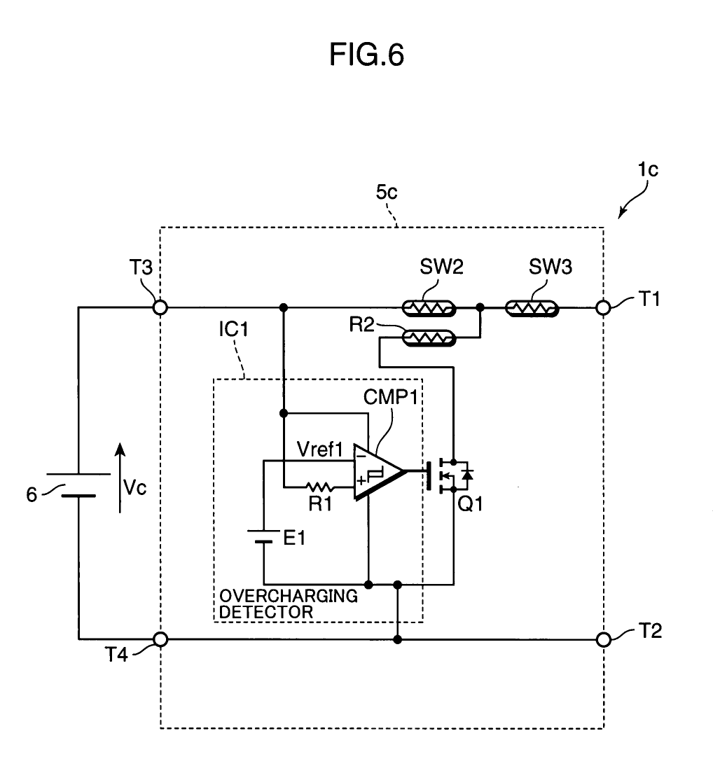

Next, a battery pack according to a fourth embodiment of the present invention is described. The external appearance of a battery pack 1c according to the fourth embodiment of the present invention is similar to that of the battery pack 1 shown in FIG. 1. FIG. 6 is a circuit diagram showing one example of the electrical construction of the battery pack 1c according to the fourth embodiment of the invention. The battery pack 1c shown in FIG. 6 is provided with a protection circuit 5c and a secondary battery 6. The secondary battery 6 is, for example, a rechargeable secondary battery such as a lithium ion secondary battery, a lithium polymer secondary battery, a nickel-metal-hydride secondary battery or a nickel-cadmium secondary battery. The protection circuit 5c is for protecting the secondary battery 6 from overcharging and excessive discharge current.

The protection circuit 5c is arranged in an external connection terminal unit 3 and includes a connection terminal T1 (first connection terminal), a connection terminal T2 (second connection terminal), a connection terminal T3 (third connection terminal), a connection terminal T4 (fourth connection terminal), two PTC elements SW2 (first PTC element), SW3 (second PTC element), a comparator CMP1, a reference voltage generator E1, a resistor R1, a transistor Q1 and a heater R2. The connection terminals T3 and T4 are connection terminals to be connected to the opposite electrodes of the secondary battery 6.

Similar to the PTC element SW1 of the first embodiment, each of the PTC elements SW2, SW3 is a PTC thermistor (PTC: Positive Temperature Coefficient=thermistor having a positive temperature coefficient) made of polymer and having a characteristic as shown in FIG. 3 and is also a return type heat-sensitive switch whose resistance value suddenly changes when the temperature thereof increases above a certain temperature.

The heater R2 shown in FIG. 6 is connected between the PTC elements SW2 and SW3 and, for example, a PTC thermistor having a positive temperature characteristic, i.e. whose resistance value increases and decreases with temperature is used as such. Thus, if a voltage is applied to the heater R2, the resistance value of the heater R2 increases due to the self-heat generation of the heater R2, thereby decreasing a current flowing through the heater R2, with the result that the temperature of the heater R2 finally stabilizes at a finally attained temperature Th. The finally attained temperature Th is set at such a temperature that is above an operating temperature Tsw1 of the PTC elements SW2, SW3 and does not damage the secondary battery 6 and the protection circuit 5c. This can suppress the damage of the secondary battery 6 and the protection circuit 5c due to the heat generation of the heater R2.

The connection terminal T3 is connected to a positive electrode of the secondary battery 6, and a negative electrode of the secondary battery 6 is connected to the connection terminal T4. Further, the connection terminal T1 is connected to a power supply terminal of the comparator CMP1 via the PTC elements SW3, SW2, and the connection terminal T2 is connected to a ground terminal of the comparator CMP1, so that a supply voltage for the operation of the comparator CMP1 is supplied from the secondary battery 6.

It should be noted that the comparator CMP1, the resistor R1 and the reference voltage generator E1 are, for example, integrated into an integrating circuit IC1. In this case, the integrating circuit IC1 corresponds to one example of an overcharging detector; the transistor Q1 to one example of a switching element; the PTC element SW2 to a first PTC element; and the PTC element SW3 to a second PTC element.

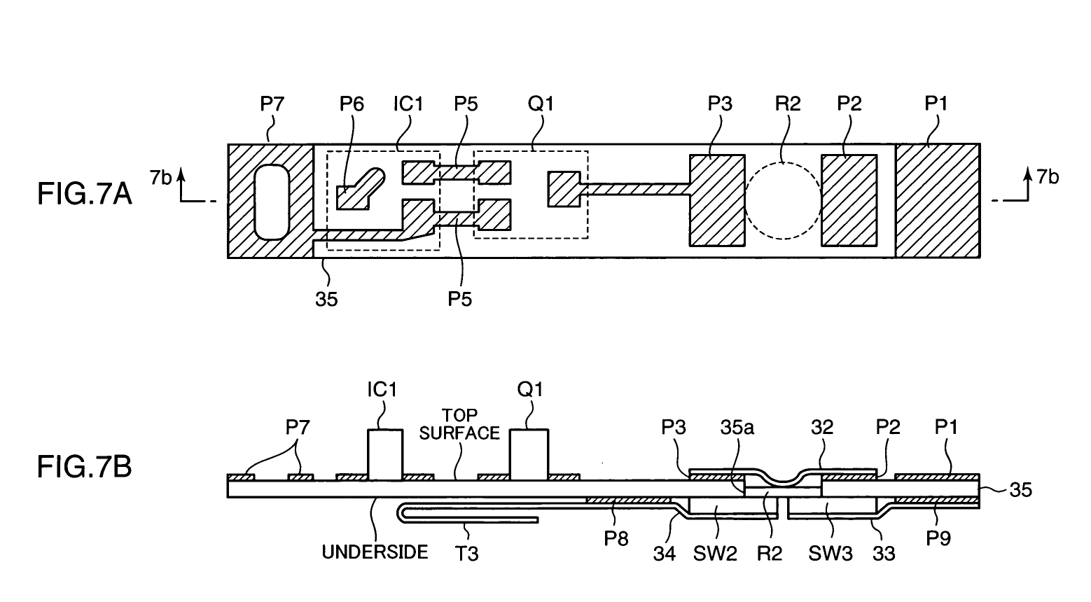

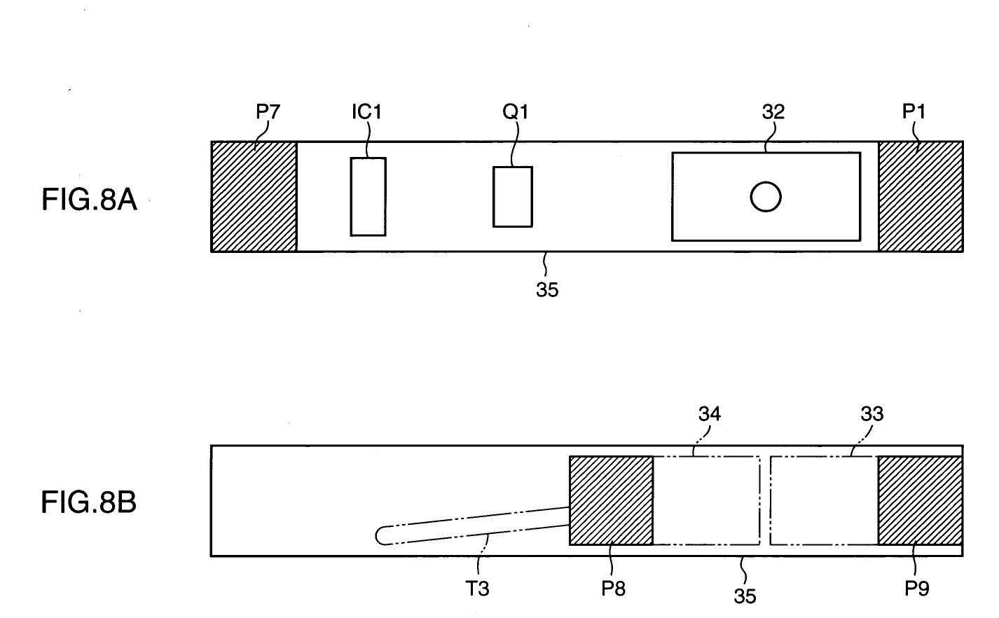

Next, the construction of the protection circuit 5c shown in FIG. 6 is described. FIGS. 7 and 8 are diagrams showing the construction of the protection circuit 5c, wherein FIG. 7A shows wiring patterns of the protection circuit 5c, FIG. 7B is a section along 7b-7b, FIG. 8A is a top view of the protection circuit 5c and FIG. 8B shows wiring patterns formed on the underside of a circuit board of the protection circuit 5c. It should be noted that mount positions of parts are shown by broken line in FIG. 7A.

Wiring patterns P1 to P7 shown in FIG. 7A are printed on the top surface of a circuit board 35. Further, wiring patterns P8, P9 are printed on the underside of the circuit board 35. The circuit board 35 is mounted in the casing 31 such that the top surface thereof faces an inner bottom surface 31a of the casing 31 of the external connection terminal unit 3 shown in FIG. 1. The wiring patterns P1 to P9 are printed on the circuit board 35 using an electroconductive wiring material in paste form made, for example, of metal fine particles.

The integrating circuit IC1 and the transistor Q1 are secured to the wiring patterns P1 to P7. A fixing member (first fixing member) 34 for fixing the PTC element SW1 to the circuit board 35 is connected with the wiring pattern P8, and a fixing member (second fixing member) 33 for fixing the PTC element SW2 to the circuit board 35 is connected with the wiring pattern P9. The tongue-shaped connection terminal T3 to be connected with the positive electrode of the secondary battery 6 is mounted at the left end of the fixing member 34. A round hole 35a is formed at the right side of the circuit board 35, and the disk-shaped heater R2 is mounted into this hole 35a such that the bottom surface thereof is flush with the underside of the circuit board 35. The PTC elements SW2, SW3 are mounted on the circuit board 35 such that the upper surfaces thereof are partly in touch with the bottom surface of the heater R2. Thus, heat of the heater R2 is transferred to the PTC elements SW2, SW3.

A sheet metal 32 is mounted on the upper surface of the heater R2. The sheet metal 32 has a recess in its middle part, and the heater R2 is fixed in the hole 35a by being held between this recess and the PTC elements SW2, SW3. The left and right sides of the sheet metal 32 are respectively connected with the wiring patterns P3, P2. The wiring patterns P9, P1 are electrically connected via an unillustrated through hole, and the wiring pattern P1 is electrically connected to the connection terminal T1 shown in FIG. 1.

Next, the operation of the protection circuit 5c constructed as above is described referring to FIG. 6. First, a protecting operation of the protection circuit 5c from overcharging is described. First, when an unillustrated charging device is connected with the connection terminals T1, T2 to apply a charging voltage between the connection terminals T1 and T2 with the PTC element SW1 turned on, the secondary battery 6 is charged with the charging voltage via the PTC element SW1 and the connection terminal T3.

The charging voltage Vc is normally up to, for example, 4.2 V. For example, 4.3 V is set as the reference voltage Vref1 in the reference voltage generator E1.

Accordingly, if the charging voltage Vc exceeds Vref1, for example, because the charging device breaks down or the output voltage accuracy thereof is low, the transistor Q1 is turned on by the comparator CMP1 to cause a current to flow into the heater R2 from the connection terminal T1 via the PTC element SW2, whereby the heater R2 is heated and the PTC elements SW2, SW3 are heated by the heater R2. When the temperatures of the PTC elements SW2, SW3 reach the operating temperature Tsw1, the PTC elements SW2, SW3 are turned off to cut off the charge current, entering an overcharging protecting state. Thus, the secondary battery 6 is protected from overcharging.

Subsequently, if the voltage Vc falls to or below the reference voltage Vref1 after the PTC elements SW2, SW3 are turned off to cut off the charge current, the transistor Q1 is turned off by the comparator CMP1 to zero the current flowing into the heater R2. When the temperatures of the PTC element SW2, SW3 fall below the operating temperature Tsw1 by natural cooling, the PTC elements SW2, SW3 are turned on to return from the overcharging protecting state to a normal state.

Since overcharging is detected by the comparator CMP1 and the PTC elements SW2, SW3 are heated by the heater R2 to be turned off in this case, accuracy in detecting overcharging can be improved as compared, for example, to the case where protection from overcharging is carried out only by the temperature switch connected in series with the secondary battery as shown in FIGS. 13 and 14. Therefore, likelihood of overcharging the secondary battery 6 without performing the overcharging protection, degrading the characteristics of the secondary battery 6 or causing the expansion or deformation of the secondary battery 6 can be reduced.

Next, a protecting operation of the protection circuit 5c in the case where a discharge current from the secondary battery 6 becomes excessive is described. First, if the connection terminals T1, T2 are short-circuited or a resistance value between the connection terminals T1 and T2 becomes low with the PTC elements SW2, SW3 turned on, for example, because a metal piece touches the connection terminals T1, T2 or an unillustrated mobile phone or a like load device connected with the connection terminals T1, T2 breaks down, a discharge current flowing from the secondary battery 6 via the PTC elements SW2, SW3 increases and the PTC elements SW2, SW3 are heated by the self-heat generation resulting from this discharge current.

When the temperatures of the PTC elements SW2, SW3 reach the operating temperature Tsw1, the PTC elements SW2, SW3 are turned off to cut off the discharge current of the secondary battery 6, thereby protecting the secondary battery 6 from excessive discharge current.

Next, the case where the integrated circuit IC1 has broken down during the charging is described. If the integrating circuit IC1 breaks down during the charging and can no longer execute a voltage control for the charging device, the secondary battery 6 goes beyond a fully charged state to enter an overcharged state.

However, if the secondary battery 6 is overcharged, the temperature of the secondary battery 6 itself increases to heat the PTC elements SW2, SW3 because the secondary battery 6 and the PTC elements SW2, SW3 are thermally coupled. The PTC elements SW2, SW3 are turned off to cut off the charge current from the charging device when the temperatures thereof reach the operating temperature Tsw1. In this way, the protection circuit 5c performs the overcharging protecting operation.

As described above, according to the battery pack 1c of the fourth embodiment, the PTC elements SW2, SW3 are turned off by the self-heat generation to cut off the discharge current if the discharge current from the secondary battery 6 exceeds the specified current value. Thus, the secondary battery 6 can be protected from excessive discharge current. Further, if the charging voltage exceeds the preset reference voltage, the heater R2 is caused to generate heat by the overcharging detector and the PTC elements SW2, SW3 are turned off to cut off the charge current by being heated by the heater R2. Thus, the secondary battery 6 can be protected from overcharging. Further, since the discharge current and the charge current can be cut off by two PTC elements SW2, SW3, the circuit can be simplified. Furthermore, since the charge current from the charging device is cut off if the PTC elements SW2, SW3 are heated by the secondary battery 6 to reach the operating temperature Tsw1, the secondary battery 6 can be protected from overcharging even if the integrated circuit IC1 breaks down during the charging.

Further, since the discharge current and the charge current can be cut off by two PTC elements SW2, SW3, the protection circuit 5c can be simplified. Furthermore, since the heater R2 is connected between the PTC elements SW2, SW3, a weak overcharging current supplied from the charging device to the secondary battery 6 during the above overcharging protecting operation flows to the heater R2 and discharged by the heater R2. This can prevent the overcharging of the secondary battery 6 from progressing by the weak current during the overcharging protecting operation.

Further, since two PTC elements SW2, SW3 are provided, even if one PTC element is broken, the secondary battery 6 can be protected from overcharging and excessive discharge current by the other PTC element, wherefore safety and reliability can be improved.

### Fifth Embodiment

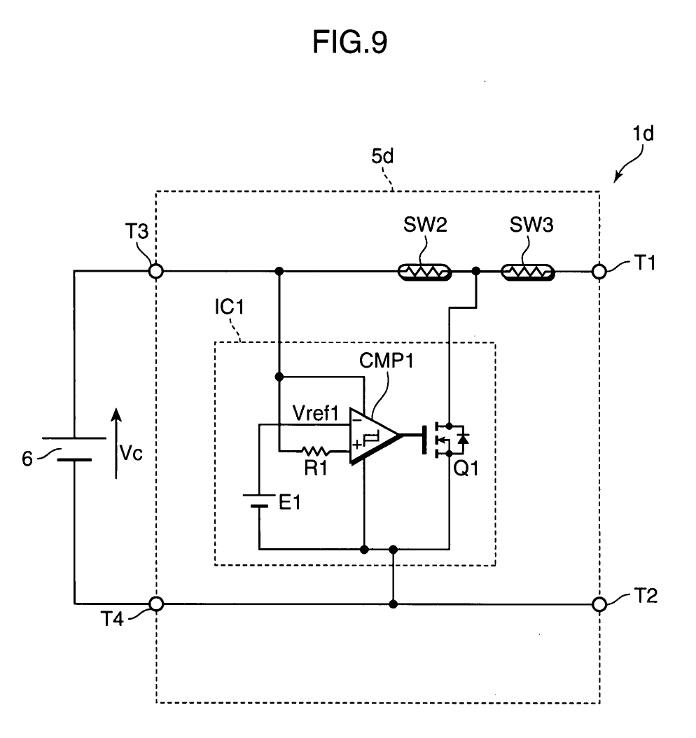

Next, a battery pack according to a fifth embodiment of the present invention is described. The external appearance of a battery pack 1d according to the fifth embodiment of the present invention is similar to that of the battery pack 1 shown in FIG. 1. FIG. 9 is a circuit diagram showing one example of the electrical construction of the battery pack 1d according to the fifth embodiment of the invention. The battery pack 1d shown in FIG. 9 differs from the battery pack 1c shown in FIG. 6 in the construction of a protection circuit 5d. Specifically, the protection circuit 5d is characterized by including a transistor Q1 in an integrating circuit IC1 to heat PTC elements SW2, SW3 by heat generated by the integrated circuit IC1. Thus, the heater R2 of the fourth embodiment is omitted.

In order to heat the PTC elements SW2, SW3 by the integrating circuit IC1, the PTC elements SW2, SW3 are arranged, for example, on the top side of a package of the integrating circuit IC1.

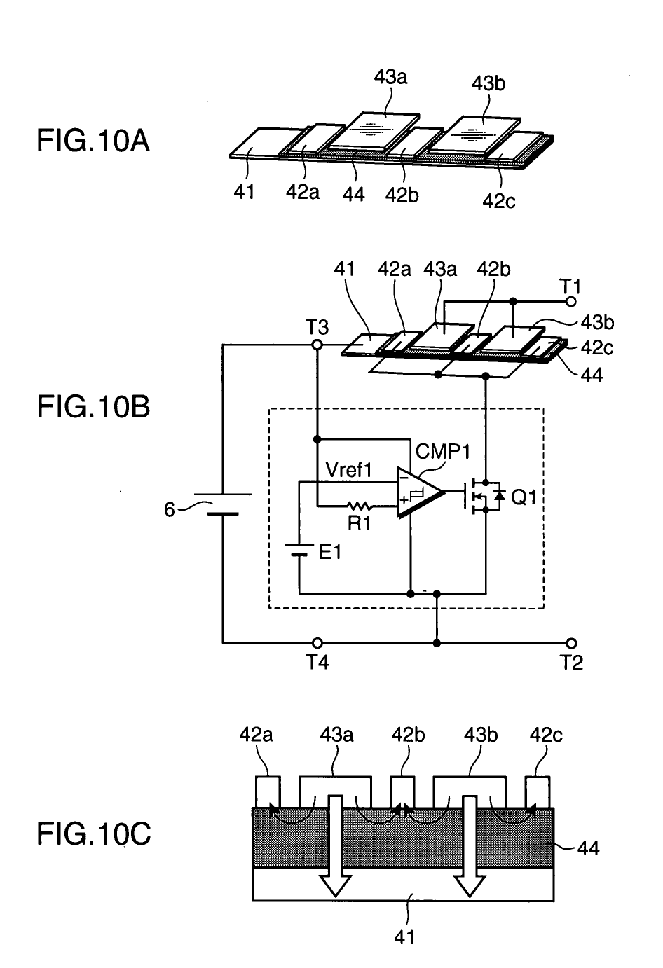

FIG. 10 are construction diagrams of the two PTC elements SW2, SW3, wherein FIG. 10A is a perspective view, FIG. 10B diagrammatically shows a mounted state of the PTC elements SW2, SW3 in the protection circuit 5d, and FIG. 10C is a diagrammatic section of the PTC elements SW2, SW3 shown in FIG. 10A. As shown in FIGS. 10A and 10B, the PTC elements SW2, SW3 include a minus electrode 41, three control electrodes 42a, 42b, 42c, plus electrodes 43a, 43b and a low resistance polymer 44. Although three control electrodes and two plus electrodes are provided in FIGS. 10A, 10B, the numbers thereof are not limited thereto. Even if four or more control electrodes and three or more plus electrodes are provided, the same effects as the case shown in FIGS. 10A, 10B can be obtained.

The minus electrode 41, the control electrodes 42a to 42c, the plus electrodes 42a, 42b are all flat members. Sectional areas of the plus electrodes 43a, 43b at the side of the low resistance polymer 44 are larger than those of the control electrodes 42a to 42c at the side of the low resistance polymer 44.

The low resistance polymer 44 is laminated on the top side of the minus electrode 41, and the control electrode 42a, the plus electrode 43a, the control electrode 42b, the plus electrode 43b and the control electrode 42c are arrayed in this order on the low resistance polymer 44.

As shown in FIG. 10B, the minus electrode 41 is connected to a positive electrode of a secondary battery 6, the control electrodes 42a, 42b, 42c are connected to the transistor Q1, and the plus electrodes 43a, 43b are connected to a connection terminal T1. The minus electrode 41, the low resistance polymer 44, the control electrode 42a and the plus electrode 43a correspond to the PTC element SW2, whereas the control electrode 42b, the plus electrode 43b and the control electrode 42c correspond to the PTC element SW3. It should be noted that each arrow in FIG. 10C shows a current flow, and the thickness thereof represents current intensity.

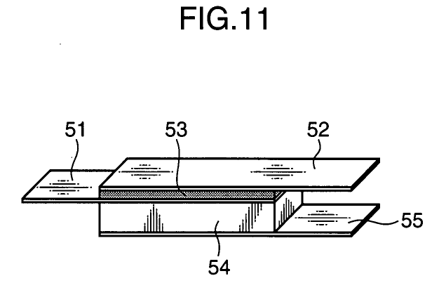

FIG. 11 is a construction diagram of a conventional PTC element. As shown in FIG. 11, the conventional PTC element is comprised of a flat control electrode 55, a high resistance polymer 54 laminated on the top side of the control electrode 55 and having a rectangular parallelepipedic shape, a minus electrode 51 laminated on the top side of the high resistance polymer 54, a low resistance polymer 53 laminated on the top side of the minus electrode 51, and a plus electrode 52 laminated on the top side of the low resistance polymer 53. The minus electrode 51 is connected to the secondary battery 6, the plus electrode 52 is connected to the first connection terminal T1, and the control electrode 55 is connected to the transistor Q1.

The conventional PTC element shown in FIG. 11 adopts such a construction that two kinds of polymers, i.e. the low resistance polymer 53 and the high resistance polymer 54 are laminated, which has led to a larger number of components and a higher cost. Further, since the high resistance polymer 54 is used, a large thickness is necessary, leading to difficulty in miniaturization.

On the other hand, in the PTC elements according to this embodiment, the control electrodes 42a to 42c and the plus electrodes 43a, 43b are both formed on the same surface of the low resistance polymer. Thus, the height of the PTC elements SW1, SW2 can be reduced. Further, since the sectional areas of the control electrodes 42a to 42c at the side of the low resistance polymer 44 are smaller than those of the plus electrodes 43a, 43b at the side of the low resistance polymer 44, resistances between the plus electrodes 43a, 43b and the control electrodes 42a, 42b are larger than those between the plus electrodes 43a, 43b and the minus electrode 41, with the result that the low resistance polymer 44 can be caused to generate heat by small currents flowing between the plus electrodes 43a, 43b and the control electrodes 42a, 42b, 42c while a large current flows between the connection terminal T1 and the secondary battery 6. Therefore, the PTC elements SW2, SW3 can be efficiently operated.

Next, the operation of the protection circuit 5d according to the fifth embodiment is described. First, a protecting operation of the protection circuit 5d from overcharging is described. First, when an unillustrated charging device is connected with the connection terminals T1, T2 to apply a charging voltage between the connection terminals T1 and T2 with the PTC elements SW2, SW3 turned on, the secondary battery 6 is charged with the charging voltage via the PTC elements SW2, SW3 and the connection terminal T3.

The charging voltage Vc is normally up to, for example, 4.2 V. For example, 4.3 V is set as the reference voltage Vref1 in the reference voltage generator E1.

Accordingly, if the charging voltage Vc exceeds Vref1, for example, because the charging device breaks down or the output voltage accuracy thereof is low, the transistor Q1 is turned on by the comparator CMP1, thereby causing the integrating circuit IC1 to generate heat. The PTC elements SW2, SW3 are heated by this heat generation. When the temperatures of the PTC elements SW2, SW3 reach an operating temperature Tsw1, the PTC elements SW2, SW3 are turned off to cut off a charge current, entering an overcharging protecting state. Thus, the secondary battery 6 can be protected from overcharging.

Subsequently, if the charging voltage Vc falls to or below the reference voltage Vref1 after the PTC elements SW2, SW3 are turned off to cut off the charge current, the transistor Q1 is turned off by the comparator CMP1, thereby stopping the heating of the PTC elements SW2, SW3 by the integrating circuit IC1. When the temperatures of the PTC elements SW2, SW3 fall below the operating temperature Tsw1 by natural cooling, the PTC elements SW2, SW3 are turned on again to return from the overcharging protecting state to a normal state.

A protecting operation of the protection circuit 5d in the case where a discharge current from the secondary battery 6 becomes excessive and a protecting operation of the protection circuit 5d in the case where the integrating circuit IC1 has broken down during the charging are not described since they are the same as in the fourth embodiment.

As described above, according to the battery pack 1d of the fifth embodiment, the heater R2 is unnecessary since the PTC elements SW2, SW3 are heated by the integrating circuit IC1, wherefore the number of parts can be reduced, the circuit can be miniaturized and the cost of the circuit can be reduced in addition to the same functions and effects of the protection circuit 5c of the fourth embodiment. Although the transistor Q1 is included in the integrating circuit IC1 in the fifth embodiment, the present invention is not limited thereto and the transistor Q1 may not be included in the integrating circuit IC1 as in the fourth embodiment. In this case, the PTC elements SW2, SW3 may be arranged in the vicinity of the transistor Q1 and may be heated by heat generated when the transistor Q1 is turned on.

### SUMMARY OF THE INVENTION

(1) A protection circuit according to the present invention comprises a first and a second connection terminals for connecting a charging device for charging a secondary battery and/or a load device driven by a discharge current from the secondary battery; a third and a fourth connection terminals connected with the opposite electrodes of the secondary battery; a PTC element that is provided between the first and third connection terminals and turned off in the case of exceeding a specified temperature; a heater for heating the PTC element; and an overcharging protection controller for turning the PTC element off by causing the heater to generate heat if a voltage of the secondary battery exceeds a preset reference voltage.

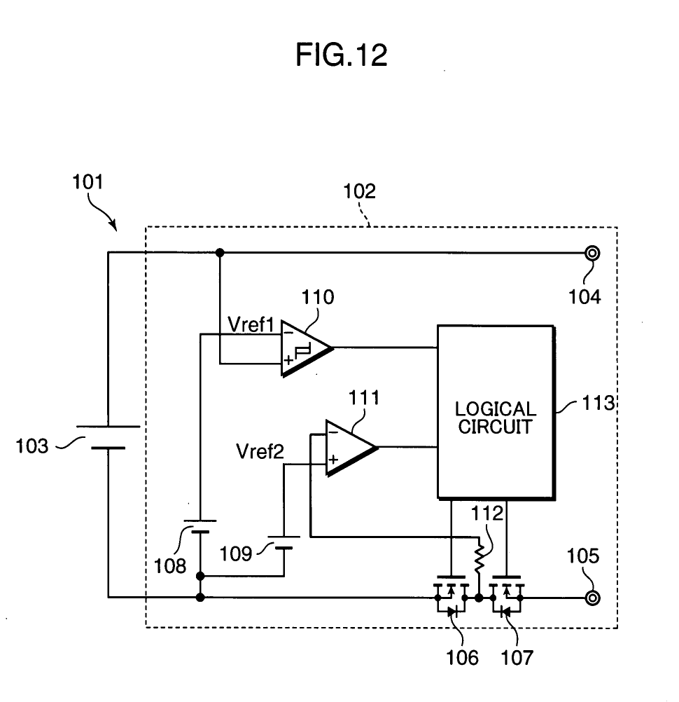

With this construction, if the discharge current from the secondary battery exceeds a specified current value, the PTC element is turned off by the self-heat generation to cut off the discharge current. Thus, the secondary battery can be protected from excessive discharge current. This obviates the need for the FET 106 for preventing overcharging, the reference voltage generator 109 and the comparator 111 for detecting an excessive discharge current, shown in FIG. 12, enabling the circuit to be simplified. Further, if the charging voltage exceeds the preset reference voltage, the heater is caused to generate heat by the overcharging protection controller and the PTC element is turned off to cut off a charge current by being heated by the heater. Thus, the secondary battery can be protected from overcharging. Further, since the discharge current and the charge current can be cut off by one PTC element, the circuit can be simplified.

(2) The heater preferably has one end thereof connected to the first connection terminal and the other end thereof connected to an output terminal of the overcharging protection controller.

With this construction, the heater can be securely turned on and off.

(3) The heater preferably has one end thereof connected to the third connection terminal and the other end thereof connected to an output terminal of the overcharging protection controller.

With this construction, since the one end of the heater is connected to the third connection terminal, a weak charge current flowing in an off-state of the PTC element flows to the overcharging protection controller via the heater, whereby the flow of this weak current to the secondary battery can be prevented to more securely prevent the overcharging of the secondary battery.

(4) It is preferable that the overcharging protection controller includes an overcharging detector for detecting whether or not the voltage of the secondary battery has exceeded the reference voltage and a switching element connected between an output terminal of the overcharging detector and the heater; and that the overcharging detector turns the switching element on if the voltage of the secondary battery exceeds the reference voltage while turning the switching element off if the voltage of the secondary battery falls to or below the reference voltage.

With this construction, the overcharging of the secondary battery can be more precisely prevented since the heater is turned on and off using the switching element.

(5) It is preferable that the overcharging detector is an integrating circuit; and that the switching element is a field effect transistor having a gate thereof connected to the output terminal of the overcharging detector.

With this construction, the circuit can be miniaturized since the overcharging detector is formed into an integrating circuit and the field effect transistor is used as the switching element.

(6) The overcharging detector preferably includes a comparator having an output terminal thereof connected to the switching element, a reference voltage generator for applying the reference voltage to one input terminal of the comparator, and a resistor connected between the other input terminal of the comparator and the third connection terminal.

With this construction, the overcharging of the secondary battery can be more accurately detected since the comparator controllably turns the switching element on and off by comparing the reference voltage and the voltage of the secondary battery.

(7) It is characterized by comprising a first and a second connection terminals for connecting a charging device for charging a secondary battery and/or a load device driven by a discharge current from the secondary battery; a third and a fourth connection terminals connected with the opposite electrodes of the secondary battery; a PTC element that is provided between the first and third connection terminals and turned off in the case of exceeding a specified temperature; an overcharging preventing transistor connected between the PTC element and the first connection terminal; and an overcharging detector for detecting whether or not a voltage of the secondary battery has exceeded a specified reference voltage and turning the overcharging preventing transistor off if the voltage of the secondary battery has exceeded the reference voltage.

With this construction, if the discharge current from the secondary battery exceeds a specified current value, the PTC element is turned off by the self-heat generation to cut off the discharge current. Thus, the secondary battery can be protected from excessive discharge current. This obviates the need for the FET 106 for preventing overcharging, the reference voltage generator 109 and the comparator 111 for detecting an excessive discharge current, shown in FIG. 12, enabling the circuit to be simplified. Further, if the charging voltage exceeds the preset reference voltage, the overcharging preventing transistor is turned off by the overcharging protection controller to cut off a charge current to the secondary battery. Therefore, the secondary battery can be protected from overcharging.

(8) It is preferable to further include a switching transistor for turning the overcharging preventing transistor off when the overcharging of the secondary battery is detected by the overcharging detector and to integrate the switching transistor and the overcharging detector into an integrating circuit.

With this construction, since the overcharging preventing transistor is turned on and off by the switching transistor, the overcharging preventing transistor having a large current rating can be accurately on-off controlled. Further, since a transistor having a small current rating can be used as the switching transistor, the switching transistor and an overcharging detecting circuit can be combined into an integrating circuit. Therefore, the circuit size can be reduced.

(9) A protection circuit according to the present invention comprises a first and a second connection terminals for connecting a charging device for charging a secondary battery and/or a load device driven by a discharge current from the secondary battery; a third and a fourth connection terminals connected with the opposite electrodes of the secondary battery; a first and a second PTC elements that are connected in series between the first and third connection terminals and turned off in the case of exceeding a specified temperature; a heater having one end thereof connected between the first and second PTC elements for heating the first and second PTC elements; a switching element having one end thereof connected with the other end of the heater and the other end thereof connected to the second and fourth connection terminals; and an overcharging detector for turning the switching element on if a voltage of the secondary battery has exceeded a specified reference voltage while turning the switching element off if the voltage of the secondary battery falls to or below the reference voltage.

With this construction, if the discharge current from the secondary battery exceeds a specified current value, the first and second PTC elements are turned off by the self-heat generation to cut off the discharge current. Thus, the secondary battery can be protected from excessive discharge current. This obviates the need for the FET 106 for preventing overcharging, the reference voltage generator 109 and the comparator 111 for detecting an excessive discharge current, shown in FIG. 12, enabling the circuit to be simplified. Further, if the voltage of the secondary battery exceeds the preset reference voltage, the switching element is turned on by the overcharging detector, a charge current flows to the heater, and the first and second PTC elements are heated by the heater to be turned off, whereby the charge current to the secondary battery is cut off to enter an overcharging protecting state. Therefore, the secondary battery can be protected from overcharging.

Further, since the discharge current and the charge current can be cut off by the first and second PTC elements, the circuit can be simplified. Furthermore, since the heater is connected between the first and second PTC elements, a weak overcharging current supplied from the charging device to the secondary battery during the overcharging protecting operation flows to the heater and is discharged by the heater. This can prevent the progress of the overcharging of the secondary battery by the weak current during the overcharging protecting operation.

Further, since two PTC elements are provided, even if one PTC element is broken, the secondary battery can be protected from overcharging and excessive discharge current by the other PTC element, wherefore safety and reliability can be improved.

(10) The overcharging detector preferably includes a comparator having an output terminal thereof connected to the switching element, a reference voltage generator for applying the reference voltage to one input terminal of the comparator and a resistor connected between the other input terminal of the comparator and the third connection terminal.

With this construction, the overcharging of the secondary battery can be more accurately detected since the comparator controllably turns the switching element on and off by comparing the reference voltage and the voltage of the secondary battery.

(11) The switching element is preferably a field effect transistor having a gate thereof connected to the output terminal of the overcharging detector.

With this construction, the first and second PTC elements can be more securely turned off during the overcharging protecting operation since the field effect transistor is used as the switching element.

(12) It is preferable that the protection circuit is mounted on a circuit board; that the heater is mounted in a hole formed at a specified position of the circuit board such that the bottom surface thereof is flush with the underside of the circuit board; that the first and second PTC elements are so mounted on the underside of the circuit board as to partly touch the bottom surface of the heater; and that there are further provided a sheet metal mounted on the top surface of the circuit board in such a manner as to press the heater from the top side of the circuit board toward the underside, a first fixing member mounted on the underside of the circuit board in such a manner as to press the first PTC element from the underside of the circuit board toward the top side, and a second fixing member mounted on the underside of the circuit board in such a manner as to press the second PTC element from the underside of the circuit board toward the top side.

With this construction, the heater is mounted in the hole formed at the specified position of the circuit board, the first and second PTC elements are mounted on the underside of the heater, and the heater and the first PTC element are held between the sheet metal and the first fixing member while the heater and the second PTC element are held between the sheet metal and the second fixing member. Thus, the heater, the first PTC element and the second PTC element can be stably mounted on the circuit board while the first and second PTC elements are brought into contact with the heater.

(13) The switching element and the overcharging detector are preferably constructed by one integrating circuit.

With this construction, the circuit can be miniaturized since the switching element and the overcharging detector are constructed by one integrating circuit.

(14) It is preferable that the switching element heats the first and second PTC elements by power consumed when being turned on, and that the heater is constructed by the switching element.

With this construction, since the first and second PTC elements are heated utilizing heat generated when the switching element is turned on, the heater is unnecessary, which leads to a reduced number of parts and the miniaturization of the circuit.

(15) The first and second PTC elements are preferably constructed to have a comb shape by a flat minus electrode, a low resistance polymer laminated on the top side of the minus electrode, a plurality of plus electrodes laminated on the top side of the low resistance polymer, and a plurality of control electrodes laminated on the top side of the low resistance polymer, the plus electrodes and the control electrodes being alternately arranged, wherein the sectional areas of the plus electrodes at the side of the low resistance polymer are larger than those of the control electrodes at the side of the low resistance polymer.

With this construction, the elements can be made thinner as compared to the conventional construction shown in FIG. 11 since the plurality of control electrodes and the plurality of plus electrodes are laminated on the same surface of the low resistance polymer. Further, the plurality of control electrodes and the plurality of plus electrodes are alternately arranged on the same surface of the low resistance polymer to have a comb shape, and the sectional areas of the plus electrodes at the side of the low resistance polymer are larger than those of the control electrodes at the side of the low resistance polymer. Thus, the low resistance polymer can be caused to generate heat by small currents flowing between the plus electrodes and the control electrodes while large currents flow between the plus electrodes and the minus electrode, wherefore the first and second PTC elements can be efficiently operated. Further, the first and second PTC elements can be integrally formed.

(16) A battery pack according to the present invention comprises a secondary battery and the protection circuit as defined in any one of the above (1), (7) and (9).

With this construction, a battery pack capable of protecting the secondary battery from overcharging and excessive discharge current can be provided while the circuit is simplified.

### INDUSTRIAL APPLICABILITY

According to the present invention, a protection circuit and a battery pack capable of protecting a secondary battery from overcharging and excessive discharge current by a simple circuit can be realized and are useful as a mobile device or a drive power source.

1-16. (canceled)

17. A protection circuit, comprising:
a first and a second connection terminals for connecting a charging device for charging a secondary battery and/or a load device driven by a discharge current from the secondary battery;
a third and a fourth connection terminals connected with the opposite electrodes of the secondary battery;
a PTC element that is provided between the first and third connection terminals and turned off in the case of exceeding a specified temperature;
a heater for heating the PTC element; and
an overcharging protection controller for turning the PTC element off by causing the heater to generate heat if a voltage of the secondary battery exceeds a preset reference voltage.

18. The protection circuit according to claim 17, wherein the heater has one end thereof connected to the first connection terminal and the other end thereof connected to an output terminal of the overcharging protection controller.

19. The protection circuit according to claim 17, wherein the heater has one end thereof connected to the third connection terminal and the other end thereof connected to an output terminal of the overcharging protection controller.

20. The protection circuit according to claim 18, wherein:
the overcharging protection controller includes an overcharging detector for detecting whether or not the voltage of the secondary battery has exceeded the reference voltage and a switching element connected between an output terminal of the overcharging detector and the heater; and
the overcharging detector turns the switching element on if the voltage of the secondary battery exceeds the reference voltage while turning the switching element off if the voltage of the secondary battery falls to or below the reference voltage.

21. The protection circuit according to claim 20, wherein:
the overcharging detector is an integrating circuit; and
the switching element is a field effect transistor having a gate thereof connected to the output terminal of the overcharging detector.

22. The protection circuit according to claim 20, wherein the overcharging detector includes:
a comparator having an output terminal thereof connected to the switching element,
a reference voltage generator for applying the reference voltage to one input terminal of the comparator, and
a resistor connected between the other input terminal of the comparator and the third connection terminal.

23. A protection circuit, comprising:
a first and a second connection terminals for connecting a charging device for charging a secondary battery and/or a load device driven by a discharge current from the secondary battery;
a third and a fourth connection terminals connected with the opposite electrodes of the secondary battery;
a PTC element that is provided between the first and third connection terminals and turned off in the case of exceeding a specified temperature;
an overcharging preventing transistor connected between the PTC element and the first connection terminal; and
an overcharging detector for detecting whether or not a voltage of the secondary battery has exceeded a specified reference voltage and turning the overcharging preventing transistor off if the voltage of the secondary battery has exceeded the reference voltage.

24. The protection circuit according to claim 23, further comprising a switching transistor for turning the overcharging preventing transistor off when the overcharging of the secondary battery is detected by the overcharging detector, the switching transistor and the overcharging detector being integrated into an integrating circuit.

25. A protection circuit, comprising:
a first and a second connection terminals for connecting a charging device for charging a secondary battery and/or a load device driven by a discharge current from the secondary battery;
a third and a fourth connection terminals connected with the opposite electrodes of the secondary battery;
a first and a second PTC elements that are connected in series between the first and third connection terminals and turned off in the case of exceeding a specified temperature;
a heater having one end thereof connected between the first and second PTC elements for heating the first and second PTC elements;
a switching element having one end thereof connected with the other end of the heater and the other end thereof connected to the second and fourth connection terminals; and
an overcharging detector for turning the switching element on if a voltage of the secondary battery has exceeded a specified reference voltage while turning the switching element off if the voltage of the secondary battery falls to or below the reference voltage.

26. The protection circuit according to claim 25, wherein the overcharging detector includes:
a comparator having an output terminal thereof connected to the switching element,
a reference voltage generator for applying the reference voltage to one input terminal of the comparator, and
a resistor connected between the other input terminal of the comparator and the third connection terminal.

27. The protection circuit according to claim 25, wherein the switching element is a field effect transistor having a gate thereof connected to the output terminal of the overcharging detector.

28. The protection circuit according to claim 25, wherein:
the protection circuit is mounted on a circuit board;
the heater is mounted in a hole formed at a specified position of the circuit board such that the bottom surface thereof is flush with the underside of the circuit board;
the first and second PTC elements are so mounted on the underside of the circuit board as to partly touch the bottom surface of the heater; and
the protection circuit further comprises:
a sheet metal mounted on the top surface of the circuit board in such a manner as to press the heater from the top side of the circuit board toward the underside,
a first fixing member mounted on the underside of the circuit board in such a manner as to press the first PTC element from the underside of the circuit board toward the top side, and
a second fixing member mounted on the underside of the circuit board in such a manner as to press the second PTC element from the underside of the circuit board toward the top side.

29. The protection circuit according to claim 25, wherein the switching element and the overcharging detector are constructed by one integrating circuit.

30. The protection circuit according to claim 25, wherein the switching element heats the first and second PTC elements by power consumed when being turned on, the heater being constructed by the switching element.

31. The protection circuit according to claim 25, wherein the first and second PTC elements are constructed to have a comb shape by:
a flat minus electrode,
a low resistance polymer laminated on the top side of the minus electrode,
a plurality of plus electrodes laminated on the top side of the low resistance polymer, and
a plurality of control electrodes laminated on the top side of the low resistance polymer,
the plus electrodes and the control electrodes being alternately arranged, and
the sectional areas of the plus electrodes at the side of the low resistance polymer being larger than those of the control electrodes at the side of the low resistance polymer.

32. A battery pack, comprising:
a secondary battery; and
the protection circuit according to claim 17.
